(19) United States
(12) Patent Application Publication
(10) Pub. No.: US 2024/0145751 A1
(43) Pub. Date: May 2, 2024

(54) CHLORINE DIOXIDE-BASED ENERGY STORAGE

(71) Applicant: FORM ENERGY, INC., Somerville, MA (US)

(72) Inventors: Liang SU, Medfield, MA (US); Yet-Ming CHIANG, Weston, MA (US); Merrill K. CHIANG, Weston, MA (US)

(21) Appl. No.: 18/495,412

(22) Filed: Oct. 26, 2023

Related U.S. Application Data
(60) Provisional application No. 63/381,037, filed on Oct. 26, 2022.

(51) Int. Cl. H01M 8/22; H01M 4/96; H01M 8/18; H01M 10/05

(52) U.S. Cl. CPC H01M 8/222; H01M 4/96; H01M 8/186; H01M 8/22; H01M 10/05; H01M 2004/8689

(57) ABSTRACT

According to one aspect, an electrochemical cell may include a positive electrode, a negative electrode, and an electrolyte separating the positive electrode and the negative electrode from one another. The positive electrode, the negative electrode, and the electrolyte may collectively store and discharge energy by an electrode reaction of chlorine dioxide (ClO₂).

### CROSS-REFERENCE TO RELATED APPLICATIONS

This application claims the benefit of priority to U.S. Provisional Patent Application 63/381,037, filed Oct. 26, 2022, the entire contents of which are hereby incorporated herein by reference.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

### SUMMARY

According to one aspect, an electrochemical cell may include a positive electrode, a negative electrode, and an electrolyte separating the positive electrode and the negative electrode from one, and the positive electrode, the negative electrode, and the electrolyte collectively discharging energy by an electrode reaction of chlorine dioxide (ClO2).

In some implementations, the electrolyte may be circulatable between the positive electrode and the negative electrode.

In certain implementations, at least one of the positive electrode and the negative electrode may be a gas diffusion electrode.

In some implementations, the positive electrode has a chlorite (ClO₂⁻)/chlorine dioxide (ClO₂) couple thereon. In some instances, the electrolyte has a pH greater than 10. Further, or instead, the positive electrode has an active layer including carbon and polytetrafluoroethylene (PTFE). For example, the active layer of the positive electrode may be platinum-free. Further, or instead, the electrolyte may include a hydroxide, and hydroxide ion is movable between the positive electrode and the negative electrode via the electrolyte. As an example, the hydroxide may include lithium hydroxide (LiOH), sodium hydroxide (NaOH), potassium hydroxide (KOH), and cesium hydroxide (CsOH), or a combination thereof. In some instances, the negative electrode may have a proton/hydrogen (H₂) couple thereon. In certain instances, the negative electrode may have an ammonia (NH₃)/nitrogen (N₂)/hydrogen (H₂) couple thereon. As an example, the negative electrode may include one or more platinum group metal electrocatalysts. As another example, the negative electrode may include one or more non-platinum group metal electrocatalysts. The one or more non-platinum group metal electrocatalysts may include alloys and/or intermetallic compounds, and the alloys and/or intermetallic compounds include manganese, iron, cobalt, nickel, copper, or a combination thereof.

In certain implementations, the positive electrode may have thereon a chlorite (ClO₂⁻)/chlorine dioxide (ClO₂) couple thereon, and the negative electrode includes aluminum.

According to another aspect, a method of operating an electrochemical cell may include generating a voltage difference between a reaction couple on a first electrode and a chlorite/chlorine dioxide couple on a second electrode, and collecting electric current formed by ions moving, in response to the voltage difference, through an electrolyte separating the first electrode from the second electrode.

In some implementations, the second electrode may be a gas diffusion electrode, and generating the voltage difference includes supplying chlorine dioxide gas to the second electrode.

In certain implementations, the first electrode may be a gas diffusion electrode, and generating the voltage difference includes supplying hydrogen or ammonia gas to the first electrode.

In some implementations, generating the voltage difference may include removing chlorite (ClO₂) from the electrochemical cell, converting the chlorite (ClO₂) back to chlorine dioxide (ClO₂) outside of the electrochemical cell, and returning the chlorine dioxide (ClO₂) to the electrochemical cell.

In certain implementations, generating the voltage difference may include electrochemically producing chlorine dioxide (ClO₂) from chlorite (ClO₂) and/or chemically producing chlorine dioxide (ClO₂) from one or more of chlorite (ClO₂⁻), hypochlorite (ClO⁻), or hydrochloric acid (HCl).

### DESCRIPTION OF THE DRAWINGS

FIG. 1A is a schematic representation of an electrochemical cell.

FIG. 1B is a schematic representation of a rechargeable battery.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

Generally, the term “about” and the symbol “˜” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

As used herein, unless specified otherwise the terms %, weight % (abbreviated wt %), and mass % are used interchangeably and refer to the weight of a first component as a percentage of the weight of a total formulation, mixture, particle, pellet, agglomerate, material, structure, or product, as the case may be in the context of the usage. As used herein, unless specified otherwise “volume %” and “% volume” and similar such terms refer to the volume of a first component as a percentage of the volume of the total formulation, mixture, particle, pellet, agglomerate, material, structure, or product, as the case may be in the context of the usage.

As used herein, unless specified otherwise the term “molar”, abbreviated “M” is used to refer to molar concentration, also called molarity, defined as the number of moles per liter (mol/L) of a substance in a solution. As an example, a substance at a concentration of 1 mol/L in a solution may be referred to herein as being 1 M or at a concentration of 1 M. Similarly, a millimolar (mM) is used herein to mean one thousandth of a mole per liter.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

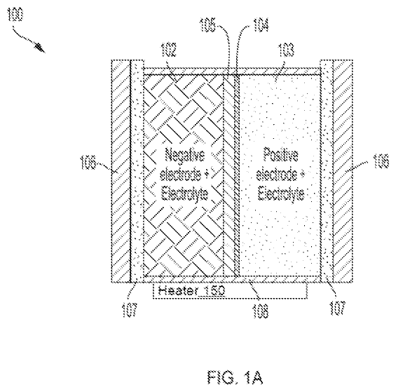

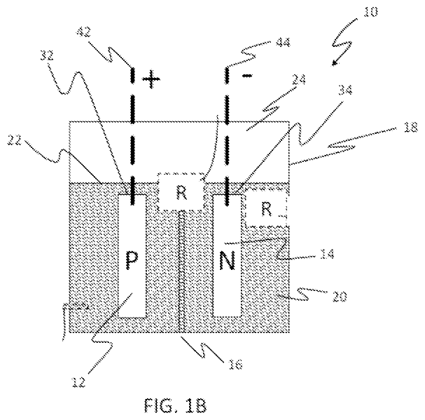

Referring now to FIG. 1A, an electrochemical cell 100 (e.g., a battery) may include a negative electrode 102 separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and positive electrode 103 and supported by backing plates 106 (e.g., polyethylene or polypropylene backing plates). In some embodiments, the temperature of the electrochemical cell 100, may be controlled, such as by insulation around the electrochemical cell 100 and/or by a heater 150. For example, the heater 150 may raise the temperature of the electrochemical cell 100 and/or specific components of the cell, such as an electrolyte infiltrated in the negative electrode 102 and the positive electrode 103. The electrolyte may be an aqueous solution. In certain embodiments the electrolyte may be an alkaline solution (pH>10). In certain embodiments, the electrolyte may be a near-neutral solution (10>pH>4).

The electrochemical cell 100 is merely an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

Referring now to FIG. 1B, a rechargeable battery 10 may include a positive electrode 12, a negative electrode 14, and a separator 16 within a container 18 filled with electrolyte 20 to a level 22 at least as high as the respective tops 32, 34 of the electrodes 12, 14. The space above the level 22 of the electrolyte 20 may be referred to as the headspace 24. The positive electrode 12 may be electrically connected to a positive terminal 42 of the rechargeable battery 10 and may contain active material that may undergo reduction reactions during discharging and oxidation reactions during charging. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 in FIG. 1B is merely an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a battery 10 may include a separator 16 that allows transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the container 18 may be made of any suitable materials and construction capable of containing the electrolyte, electrodes, and at least a minimum amount of gas pressure. For example, the container 18 may be made of metals, plastics, composite materials, or others. In some embodiments, the battery container 18 may be sealed so as to prevent the escape of any gases generated during operation of the battery.

In some embodiments, the battery container 18 may include a pressure relief valve to allow release of gases when a gas pressure within the battery container 18 exceeds a pre-determined threshold.

While the electrodes 12, 14 are shown substantially spaced apart in the figures, in some embodiments the electrodes may be very close to one another or even compressed against one another with a separator 16 in between. Furthermore, although the figures may illustrate a single positive electrode 12 and a single negative electrode 14, battery systems within the scope of the present disclosure may also include two or more positive electrodes 12 and/or two or more negative electrodes 14.

Having described aspects of the electrochemical cell 100 and the rechargeable battery 10, attention is now directed to aspects of batteries including one or more electrochemical cells including chlorine dioxide chemistries. Unless otherwise specified or made clear from the context, it shall be appreciated that any one or more of the various aspects of chlorine dioxide chemistries may be implemented using the electrochemical cell 100 and/or the rechargeable battery 10.

Hydrogen/Chlorine Dioxide Batteries

Various embodiments may include hydrogen (H₂)/chlorine dioxide (ClO₂) batteries. For example, some batteries may include a chemistry using a chlorite (ClO₂⁻)/chlorine dioxide (ClO₂) couple on the positive electrode and proton/hydrogen couple on the negative electrode.

In some embodiments, the H₂/ClO₂ battery may be a primary battery operating in an alkaline environment, with hydroxide ion as the working ion moving from the positive electrode side to the negative electrode side. For example, the positive electrode reaction may be: 2ClO₂+2e⁻=>2ClO₂₋E0+=0.954V vs SHE. Continuing with this example, the negative electrode reaction may be: H₂+2OH—−2e⁻=>2H₂O E0—=−0.828V vs SHE. The equilibrium cell voltage in such implementations is 1.782V.

In some embodiments, both the negative (H₂) electrode and the positive (ClO₂) electrode may be gas diffusion electrodes. In some examples, hydrogen gas may be continuously supplied to the negative electrode. Additionally, or alternatively, ClO₂ gas may be continuously supplied to the positive electrode.

In certain implementations, the negative (H₂) electrode and the positive (ClO₂) electrode are separated by an electrolyte including hydroxide, with the electrolyte circulating between the negative electrode and the positive electrode in some instances. In some implementations, the hydroxide may include LiGH, NaOH, KOH, CsOH, or a combination thereof. In certain embodiments, the positive (ClO₂) electrode may include only carbon and polytetrafluoroethylene (PTFE) in the active layer of the positive electrode, given that the facile kinetics of reaction of ClO₂ to ClO₂⁻ does not require any other catalyst (such as platinum). That is, the positive (ClO₂) electrode may be platinum-free. Chlorite (ClO₂) is the reaction product, which may be circulated out of the electrochemical cell, and converted back to ClO₂ in a separate unit. In some embodiments, this ex situ conversion of ClO₂⁻ back to ClO₂ may be realized through an electrochemical reaction. Additionally, or alternatively, this ex situ conversion of ClO₂⁻ back to ClO₂ may be realized through a chemical reaction.

Ammonia/Chlorine Dioxide Batteries

Various embodiments may include ammonia (NH₃)/chlorine dioxide (ClO₂) batteries. For example, some batteries may include chemistry using a chlorite (ClO₂)/chlorine dioxide (ClO₂) couple on the positive electrode and an ammonia (NH₃)/nitrogen (N₂)/hydrogen (H₂) couple on the negative electrode. In some embodiments, the NH₃/ClO₂ battery may be a primary battery operating in an alkaline environment, with the hydroxide ion as the working ion moving from the positive electrode side to the negative electrode side. For example, the positive electrode reaction may be: 2ClO₂+2e−=>2ClO₂ E0+=0.954V=0.954V vs SHE. Continuing with this example, the negative electrode reaction may be: 2NH₃+6OH⁻−6e−=>N2+6H₂O E0−=−0.278V vs SHE. The equilibrium cell voltage in such implementations is 1.232V.

In some embodiments, both the negative (NH₃) electrode and the positive (ClO₂) electrode may be gas diffusion electrodes. In some embodiments, ammonia gas may be continuously supplied to the negative electrode. Additionally, or alternatively, ClO₂ gas may be continuously supplied to the positive electrode.

In some embodiments, the negative (NH₃) electrode and the positive (ClO₂) electrode may be separated by an electrolyte including hydroxide, with the electrolyte circulating between the negative electrode and the positive electrode in some instances. In some embodiments, the hydroxide may include LiGH, NaOH, KOH, CsOH, or a combination thereof. In some embodiments, the negative (NH₃) electrode may include electrocatalysts including, but not limited to, platinum group metal (PGM). In some embodiments, the negative (NH₃) electrode may include non-PGM electrocatalysts. For example, such non-PGM catalysts may be alloys or intermetallic compounds including, but not limited to, manganese, iron, cobalt, nickel, and/or copper. In certain embodiments, the positive (ClO₂) electrode may include only carbon and PTFE in the active layer, given that the facile kinetics of reaction of ClO₂ to ClO₂⁻ does not require any other catalyst (such as platinum). That is, the positive (ClO₂) electrode may be platinum-free. Chlorite (ClO₂⁻) is the reaction product, which may be circulated out of the electrochemical cell, and converted back to ClO₂ in a separate unit. In some embodiments, this ex situ conversion of ClO₂⁻ to ClO₂ may be realized through an electrochemical reaction. Further, or instead, this ex situ conversion of ClO₂⁻ to ClO₂ may be realized through a chemical reaction.

Aluminum/Chlorine Dioxide Batteries

Various embodiments may include aluminum (Al)/chlorine dioxide (ClO₂⁻) batteries. Aluminum is a low-cost metal that can be used as the anode active material in a primary battery. However, aluminum is unstable in either alkaline or acidic electrolyte, producing hydrogen in both cases. Aluminum may be used as the anode in aluminum/air batteries, with alkaline electrolyte used for a better kinetics of the oxygen reduction reaction. Aluminum is alloyed with other more expensive metals, and electrolyte additives may be needed to mitigate the corrosion on the aluminum anode.

Various embodiments may include a high voltage primary battery including aluminum (Al) as the anode and chlorine dioxide (ClO₂) as the cathode. For example, the battery may be operated in a near neutral electrolyte such that the reactions include: Al-3e⁻=>Al₃⁺E0+−1.662V vs SHE and 3ClO₂+3e=>3ClO₂⁻E0−=0.954V vs SHE. In such implementations, the equilibrium cell voltage is 2.62V.

In certain embodiments, the battery may be operated in an alkaline electrolyte such that the reactions include: Al+3OH—−3e⁻=>Al(OH)₃⁺E0+=2.31V vs SHE and 3ClO₂+3e⁻=>3ClO₂⁻E0−=0.954V vs SHE. In such implementations, the equilibrium cell voltage is 3.26V.

In certain embodiments, ClO₂ may be in the gas phase and the cathode may be a gas diffusion electrode.

In some embodiments, ClO₂ may be produced electrochemically from chlorite. Further, or instead, ClO₂ may be produced chemically using chlorite, hypochlorite, and hydrochloric acid.

Various embodiments may include energy storage systems, such as a long duration energy storage systems, etc., including any one or more of the H₂/ClO₂batteries described herein, one or more NH₃/ClO₂ batteries described herein, one or more of the Al/ClO₂ batteries described herein, and/or combinations thereof.

Having described certain aspects chemistries of the electrochemical cell 100 and the battery 10, additional or alternative aspects these chemistries are described by way of non-limiting example in Chiang, M. K. et al, “Reversible Chlorite Anion/Chlorine Dioxide Redox Couple for Low-Cost Energy Storage,” J. Phys. Chem. C 2023, 127, 3921-3927, the entire contents of which are hereby incorporated herein by reference.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the scope of the present disclosure is not intended to be limited to the embodiments shown herein but is to be accorded the widest scope consistent with the following claims and the principles and novel features disclosed herein.

What is claimed is:

1. An electrochemical cell comprising:
a positive electrode;
a negative electrode; and
an electrolyte separating the positive electrode and the negative electrode from one, and the positive electrode, the negative electrode, and the electrolyte collectively discharging energy by an electrode reaction of chlorine dioxide (ClO₂).

2. The electrochemical cell of claim 1, wherein the electrolyte is circulatable between the positive electrode and the negative electrode.

3. The electrochemical cell of claim 1, wherein at least one of the positive electrode and the negative electrode is a gas diffusion electrode.

4. The electrochemical cell of claim 1, wherein the positive electrode has thereon a chlorite (ClO₂⁻)/chlorine dioxide (ClO₂) couple.

5. The electrochemical cell of claim 4, wherein the electrolyte has a pH greater than 10.

6. The electrochemical cell of claim 4, wherein the positive electrode has an active layer including carbon and polytetrafluoroethylene (PTFE).

7. The electrochemical cell of claim 6, wherein the active layer of the positive electrode is platinum-free.

8. The electrochemical cell of claim 4, wherein the electrolyte includes a hydroxide, and hydroxide ion is movable between the positive electrode and the negative electrode via the electrolyte.

9. The electrochemical cell of claim 8, wherein the hydroxide includes lithium hydroxide (LiOH), sodium hydroxide (NaOH), potassium hydroxide (KOH), and cesium hydroxide (CsOH), or a combination thereof.

10. The electrochemical cell of claim 8, wherein the negative electrode has a proton/hydrogen (H₂) couple thereon.

11. The electrochemical cell of claim 8, wherein the negative electrode has an ammonia (NH₃)/nitrogen (N₂)/hydrogen (H₂) couple thereon.

12. The electrochemical cell of claim 11, wherein the negative electrode includes one or more platinum group metal electrocatalysts.

13. The electrochemical cell of claim 11, wherein the negative electrode includes one or more non-platinum group metal electrocatalysts.

14. The electrochemical cell of claim 13, wherein the one or more non-platinum group metal electrocatalysts includes alloys and/or intermetallic compounds, and the alloys and/or intermetallic compounds include manganese, iron, cobalt, nickel, copper, or a combination thereof.

15. The electrochemical cell of claim 1, wherein the positive electrode has thereon a chlorite (ClO₂)/chlorine dioxide (ClO₂) couple, and the negative electrode includes aluminum.

16. A method of operating an electrochemical cell, the method comprising:
generating a voltage difference between a reaction couple on a first electrode and a chlorite/chlorine dioxide couple on a second electrode; and
collecting electric current formed by ions moving, in response to the voltage difference, through an electrolyte separating the first electrode from the second electrode.

17. The method of claim 16, wherein the second electrode is a gas diffusion electrode, and generating the voltage difference includes supplying chlorine dioxide gas to the second electrode.

18. The method of claim 16, wherein the first electrode is a gas diffusion electrode, and generating the voltage difference includes supplying hydrogen or ammonia gas to the first electrode.

19. The method of claim 16, wherein generating the voltage difference includes removing chlorite (ClO₂⁻) from the electrochemical cell, converting the chlorite (ClO₂⁻) back to chlorine dioxide (ClO₂) outside of the electrochemical cell, and returning the chlorine dioxide (ClO₂) to the electrochemical cell.

20. The method of claim 16, wherein generating the voltage difference includes electrochemically producing chlorine dioxide (ClO₂) from chlorite (ClO₂⁻) and/or chemically producing chlorine dioxide (ClO₂) from one or more of chlorite (ClO₂⁻), hypochlorite (ClO⁻), or hydrochloric acid (HCl).
